(19) United States
(12) Patent Application Publication
(10) Pub. No.: US 2009/0112891 A1
(43) Pub. Date: Apr. 30, 2009

(54) System and Method for Implementing a Stackable Tabbed Interface in a Data Processing System

(76) Inventors: Adam M. Gunther, Raleigh, NC (US); Hugh E. Hockett, Raleigh, NC (US); Eric Kirchstein, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/926,256

(22) Filed: Oct. 29, 2007

(51) Int. Cl. G06F 7/00

(52) U.S. Cl. 707/100

(57) ABSTRACT

A system and method for implementing a stackable tabbed interface in a data processing system. According to an embodiment of the present invention, a file system receives a collection of organizational schemes for arranging a collection of graphical indicia associated with a collection of files in a file system. In response to receiving a collection of organizational schemes, the file system displays the collection of graphical indicia on a collection of axes, wherein each axis among the collection of axes corresponds to each organizational scheme among the collection of organizational schemes.

### BACKGROUND OF THE INVENTION

1. Technical Field

The present invention relates in general to the field of data processing systems and in particular, to the field of accessing information utilizing data processing systems. Still more particularly, the present invention relates to organizing access to information utilizing data processing systems.

2. Description of the Related Art

The Internet has fundamentally changed the way modern society communicates. Today, information that would have been difficult to obtain even ten years ago is easily accessible via the Internet. Through the utilization of a web browser, a user can gather information from websites located on the World Wide Web (WWW).

### SUMMARY OF THE INVENTION

The present invention includes a system and method for implementing a stackable tabbed interface in a data processing system. According to an embodiment of the present invention, a file system receives a collection of organizational schemes for arranging a collection of graphical indicia associated with a collection of files in a file system. In response to receiving a collection of organizational schemes, the file system displays the collection of graphical indicia on a collection of axes, wherein each axis among the collection of axes corresponds to each organizational scheme among the collection of organizational schemes.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary network in which an embodiment of the present invention may be implemented;

FIG. 2 is a block diagram depicting an exemplary data processing in which an embodiment of the present invention may be implemented;

FIG. 3 is a pictorial representation of the graphical user interface (GUI) of file system 230 according to an embodiment of the present invention; and

FIG. 4 is a high-level logical flowchart illustrating an exemplary method of implementing a stackable tabbed interface in a data processing system in accordance with an embodiment of the present invention.

### DETAILED DESCRIPTION OF AN ILLUSTRATIVE EMBODIMENT

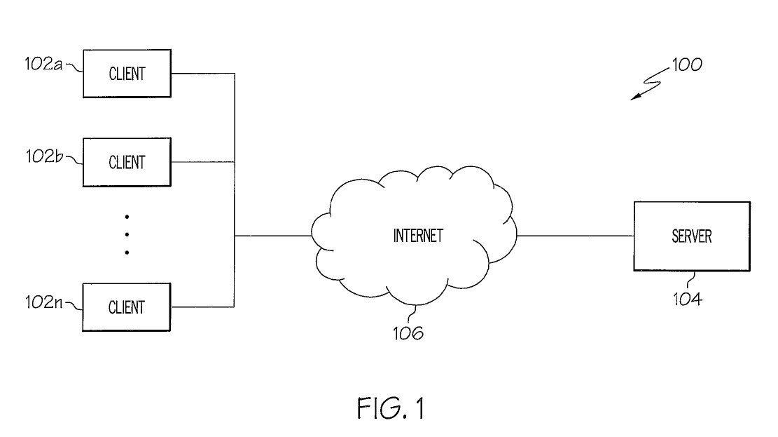

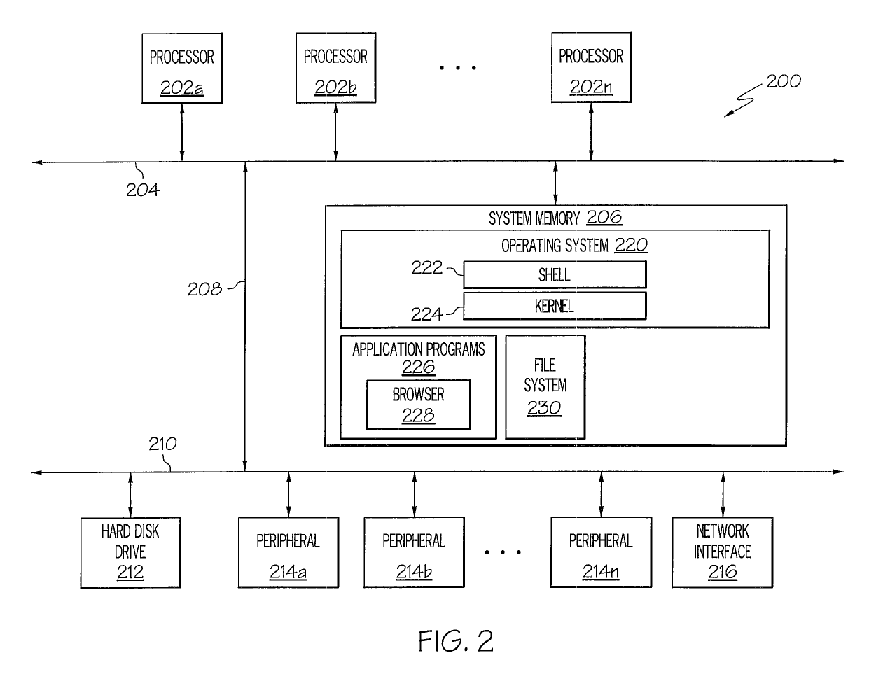

Referring now to the figures, and in particular, referring to FIG. 1, there is illustrated a block diagram depicting an exemplary network 100 in which an embodiment of the present invention may be implemented. As depicted, network 100 includes a collection of clients 102a-102n, Internet 104, and server 106. Clients 102a-102n are coupled to server 106 via Internet 104. While Internet 104 is utilized to couple clients 102a-102n to server 106, those with skill in the art will appreciate that a local-area network (LAN) or wide-area network (WAN) utilizing Ethernet, IEEE 802.11x, or any other communications protocol may be utilized. Clients 102a-102n and server 106 are discussed herein in more detail in conjunction with FIG. 2. Those with skill in the art will appreciate that exemplary network 100 may include other components such as routers, firewalls, etc. that are not germane to the discussion of the present network and will not be discussed further herein.

FIG. 2 is a block diagram depicting an exemplary data processing system 200, which may be utilized to implement clients 102a-102n and server 106 as shown in FIG. 1. As illustrated, exemplary data processing system 200 includes a collection of processors 202a-202n that is coupled to a system memory 206 via a system bus 204. System memory 206 may be implemented by dynamic random access memory (DRAM) modules or any other type of random access memory (RAM) module. Mezzanine bus 208 couples system bus 204 to peripheral bus 210. Coupled to peripheral bus 210 is a hard disk drive 212 for mass storage and a collection of peripherals 214a-214n, which may include, but are not limited to, optical drives, other hard disk drives, printers, and input devices, and the like. Network interface 216 enables data processing system 200 to communicate on a network, such as, but not limited to Internet 56.

Included in system memory 206 is operating system 220, which further includes a shell 222 (as it is called in the UNIX® operating system. UNIX® is a registered trademark of The Open Group in the United States and other countries), for providing transparent user access to resources such as application programs 226. Shell 222, also called a command processor in Microsoft® Windows® operating system, is generally the highest level of the operating system software hierarchy ad serves as a command interpreter. Microsoft® and Windows® are trademarks of Microsoft Corporation in the United States, other countries, or both. Shell 222 provides a system prompt, interprets commands entered by keyboard, mouse, or other input media, and sends the interpreted command(s) to the appropriate lower levels of the operating system (e.g., kernel 224) for processing. Note that while shell 222 is a text-based, line-oriented user interface, the present invention will support other user interface modes, such as graphical, voice, gestural, etc. equally well.

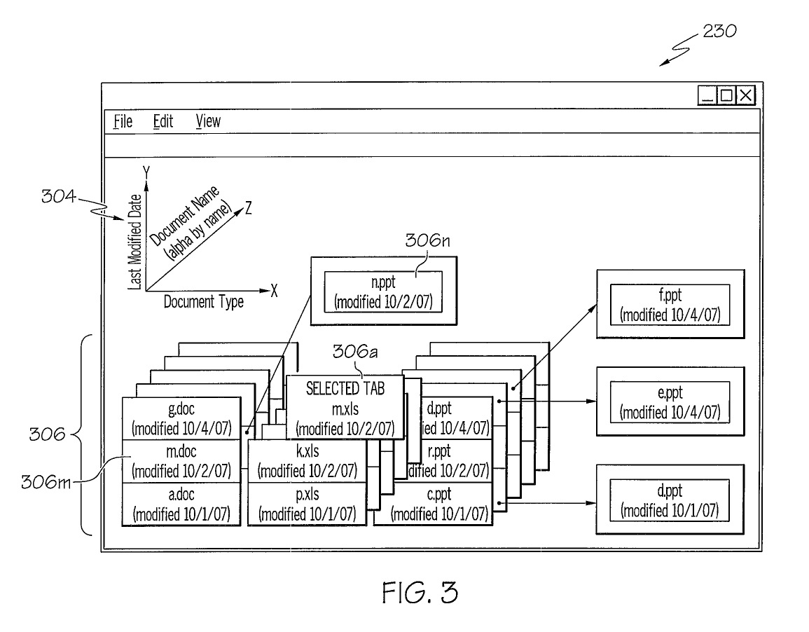

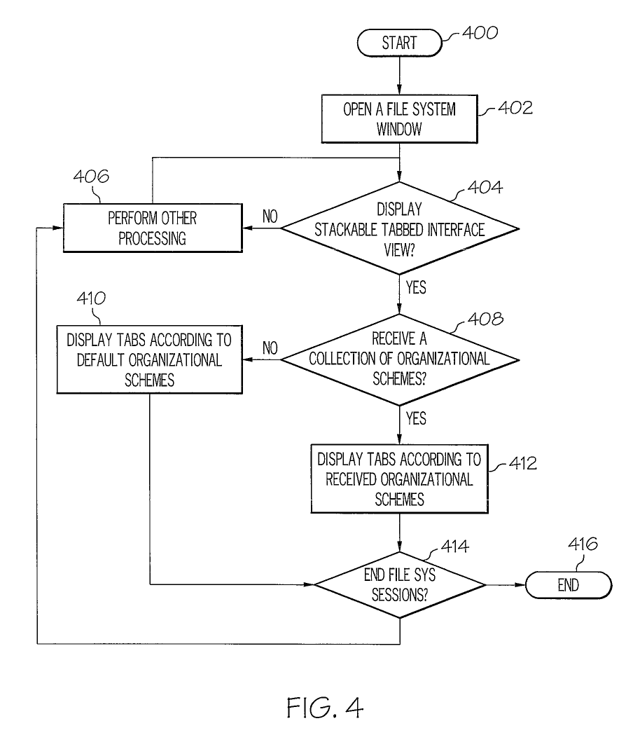

As illustrated, operating system 220 also includes kernel 224 which includes lower levels of functionality for operating system 220 and application programs 226, including memory management, process and task management, disk management, and mouse and keyboard management. Application programs 226 can include browser 228, utilized for access to Internet 104 (FIG. 1), word processors, spreadsheets, and other application programs. System memory 206 also includes a file system 230, discussed herein in more detail in conjunction with FIGS. 3 and 4, for organizing and facilitating access to files stored in system memory 206, elsewhere in data processing system 200, and/or network 100 (e.g., server 106).

FIG. 3 is a pictorial representation of the graphical user interface (GUI) of file system 230 according to an embodiment of the present invention. As illustrated, file system 230 includes a legend 304 that depicts a collection of organizational schemes (e.g., last modified date, document name (alpha by name), and document type). Also, legend 304 indicates along which axes (e.g., X, Y, or Z axis) that each organizational scheme is displayed. Those with skill in the art will appreciate that the organizational schemes and axes illustrated in FIG. 3 are for exemplary purposes only and should not be construed as a limitation. According to an embodiment of the present invention, a user can define any organization schemes that he or she wants to utilize to organize tabs 306. For example, tabs 306 can represent e-mail messages organized by sender's name, the time the message was received, and subject heading.

Tabs 306 are graphical indicia that correspond to files organized within file system 230. As shown, tabs 306 are stacked along the X, Y, and Z-axis to graphically depict three different organizational schemes. According to an embodiment of the present invention, tabs 306 include graphical indicia that represent *.doc, *.xls, and *.ppt files. These document types are organized along the X-axis. The Y-axis enables file system 230 to present documents of the same type in the order that they were last modified. The Z-axis enables file system 230 to present documents in alphabetical order by the document name. For example, tab 306m represents a file named “m.doc”. Organized along the Z-axis, tab 306n represents a file names “n.doc”.

A user can select any tab within tabs 306. As illustrated, tabs 306a (“m.xls”) depicts a currently-selected tab. A user utilizing a mouse as an input device can double-click the selected tab to open the file associated with the currently-selected tab, for example. Of course, those with skill in the art can appreciate that the user can utilize any input method and is not limited to the use of a mouse. Also, those with skill in the art will appreciate that the disclosed stackable tabbed view may be utilized within any program that may display data from multiple sources such as browser 228 and is not limited to file system 230. Those with skill in the art will also appreciate that an embodiment of the present invention enables a user to customize the stackable tabbed interface by dragging and dropping tabs 306 along any of the axes.

FIG. 4 is a high-level logical flowchart illustrating an exemplary method for implementing a stackable tabbed interface in a data processing system according to an embodiment of the present invention. As depicted, the process begins at step 400 and proceeds to step 402, which illustrates a user invoking a GUI for file system 230 in the form of a window. The process continues to step 404, which depicts file system 230 determining if the stackable tabbed view should be utilized to display the files within file system 230. If the stackable tabbed view is not to be utilized, the process continues to step 406, which illustrates file system 230 performing other processing. For example, the file system 230 may display the files in a traditional list or folder view. The process returns to step 404.

Returning to step 404, if file system 230 displays the files in file system 230 in a stackable tabbed view, the process continues to step 408, which illustrates file system 230 determining if a user (or another source such as a system administrator) has specified a collection of organizational schemes to utilize to organize tabs 306 (FIG. 3). If not, the process continues to step 410, which illustrates file system 230 displaying tabs 306 according to default organizational schemes. The process continues to step 414.

Returning to step 408, if file system 230 has received a collection of organizational schemes from a user (or another source such as a system administrator), the process continues to step 412, which depicts file system 230 displaying tabs 306 according to the received organizational schemes. The process continues to step 414.

Regarding step 414, if file system 230 has received a command from a user (or another source such as a system administrator) to end the file system session, the process ends, as illustrated in step 416. If not, the process returns to step 406.

As discussed, the present invention includes a system and method for implementing a stackable tabbed interface in a data processing system. According to an embodiment of the present invention, a file system receives a collection of organizational schemes for arranging a collection of graphical indicia associated with a collection of files in a file system. In response to receiving a collection of organizational schemes, the file system displays the collection of graphical indicia on a collection of axes, wherein each axis among the collection of axes corresponds to each organizational scheme among the collection of organizational schemes.

It should be understood that at least some aspects of the present invention may alternatively be implemented in a computer-usable medium that contains a program product. Programs defining functions in tile present invention can be delivered to a data storage system or a computer system via a variety of signal-bearing media, which include, without limitation, non-writable storage media (e.g., CD-ROM, writable storage media (e.g., hard disk drive, read/write CD-ROM, optical media), system memory such as, but not limited to random access memory (RAM), and communication media, such as computer networks and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made herein without departing from the spirit and scope of the invention.

What is claimed is:

1. A computer-implementable method for implementing a stackable tabbed interface in a data processing system, said computer-implementable method comprising:
receiving a plurality of organizational schemes for arranging a plurality of graphical indicia associated with a plurality of files in a file system; and
in response to said receiving, displaying said plurality of graphical indicia on a plurality of axes, wherein each axis among said plurality of axes corresponds to each organization scheme among said plurality of organizational schemes.

2. The computer-implementable method according to claim 1, wherein said plurality of files are a plurality of internet content files

3. The computer-implementable method according to claim 1, wherein said plurality of organizational schemes comprise organizing said plurality of graphical indicia associated with said plurality of files by file name, file location, and date of last modification.

4. A system for implementing a stackable tabbed interface, said system comprising:
at least one processor;
an interconnect coupled to said at least one processor;
a computer-usable storage medium embodying computer program code, the computer-usable storage medium being coupled to the data bus, the computer program code comprising instructions executable by the processor and configured for:
receiving a plurality of organizational schemes for arranging a plurality of graphical indicia associated with a plurality of files in a file system; and
in response to said receiving, displaying said plurality of graphical indicia on a plurality of axes, wherein each axis among said plurality of axes corresponds to each organization scheme among said plurality of organizational schemes.

5. The system according to claim 4, wherein said plurality of files are a plurality of internet content files.

6. The system according to claim 4, wherein said plurality of organizational schemes comprise organizing said plurality of graphical indicia associated with said plurality of files by file name, file location, and date of last modification.
